(19) United States
(12) Patent Application Publication
(10) Pub. No.: US 2002/0002863 A1
(43) Pub. Date: Jan. 10, 2002

(54) Velocity meter

(76) Inventors: Per Johan Slycke, Enschede (NL); Casper Peeters, Enschede (NL)

Correspondence Address: Richard L. Byrne, WEBB ZIESENHEIM LOGSDON ORKIN & HANSON, P.C., 700 Koppers Building, 436 Seventh Avenue, Pittsburgh, PA, 15219-1818, US

(21) Appl. No.: 09/809,341

(22) Filed: Mar. 15, 2001

(30) Foreign Application Priority Data
Mar. 16, 2000 (NL) NL-1014658

(51) Int. Cl. G01P 15/00

(52) U.S. Cl. 73/488; 73/490

(57) ABSTRACT

The invention relates to a device for determining velocity and optionally distance traveled by measuring successive stepping movements of an object, which device comprises:

measuring means for measuring the acceleration of the object in two main directions during a stepping movement;

processing means for determining the velocity from the measured accelerations, wherein the processing means are adapted such that

on the basis of an orientation progression the measured accelerations are integrated to a velocity and optional determination of the distance traveled;

means for displaying the velocity and optionally the distance traveled calculated by the processing means.

### BACKGROUND OF THE INVENTION

1. Field of the Invention

The invention relates to a device for determining velocity and distance traveled by measuring successive stepping movements of an object.

2. Description of the Prior Art

Measuring the velocity of an object making a stepping movement, for instance a runner, is relatively complicated. It is necessary to measure the displacement of the object relative to the earth. Since there are no parts of the object which are continuously in contact with the earth, it is not possible to measure the velocity and distance traveled with conventional measuring methods, such as applied in for instance cars.

Systems are known for measuring the velocity of an object making a stepping movement which comprise measuring means for measuring the accelerations in three main directions and the angles at which these measuring means are situated relative to the earth. Such a device is for instance known from U.S. Pat. No. 5,899,963. The angular velocities can be measured by means of gyroscopes from which the angles can be deduced by integration. Using the calculated angles and measured accelerations the velocity and the distance traveled can then be calculated by integration. The drawback of such a device is however that gyroscopes are relatively heavy and large and require a large amount of energy, whereby application of such a device is not suitable, for instance for runners. In addition, the measuring means are relatively expensive, making these systems suitable for sale to the general public.

U.S. Pat. No. 5,955,667 describes a simpler measuring device, wherein the acceleration is measured in two directions and only one angle is further measured using an angle sensor which has the above mentioned drawbacks. The measuring device must further be placed on for instance a shoe such that the first direction for measuring accelerations is the running direction and that the second acceleration measuring direction is directed perpendicularly upward. The angle at which the shoe is situated is then measured with the angle sensor. It is thus assumed that the shoe moves in a vertical plane during the stepping movement. This is by no means the case during the stride of a person. Everyone has their own stride, wherein the foot moves in all directions and turns in different directions. The sensor must furthermore be arranged in perfect alignment with the shoe. Such a device has a measuring error which depends on the person and thus only provides estimates of the velocity and the distance traveled.

WO-A-99 44016 describes a very simplified measuring device, which only contains one accelerometer. The measured signal is integrated in order to obtain an indication of the forward velocity. This indication is converted to a velocity by means of an empirically determined factor. This velocity is an indication of the velocity of the object, but will contain a considerable error if for instance the velocity meter is not situated in the plane of the movement or if the actual stepping movement differs from the stepping movement on the basis of which the empirical factor is determined.

It is an object of the invention to provide a measuring device which wholly or partially obviates the above stated drawbacks.

### SUMMARY OF THE INVENTION

This object is achieved according to the invention by a device which comprises:

measuring means for measuring the acceleration of the object in two main directions during a stepping movement;

processing means for determining the velocity from the measured accelerations, wherein the processing means are adapted such that

on the basis of an orientation progression the measured accelerations are integrated to a velocity and optional determination of the distance traveled;

means for displaying the velocity and optionally the distance traveled calculated by the processing means.

The main directions do not necessarily have to be perpendicular to each other, but in the measurement of two directions they may not lie in one line and in the measurement of three directions they may not lie in one plane.

By starting from a standard orientation progression of the object it becomes possible to transform the accelerations of the object in the main directions into the accelerations of the object relative to the earth. This makes it possible to determine the velocity of the object, and therefore also the distance traveled. After measuring the stepping movement it is possible to determine on the basis of a number of criteria whether the chosen orientation progression was correct, or whether an adjusted orientation progression must be used in order to achieve a greater accuracy. By continually improving the orientation progression the measuring error is minimized and changing running conditions are also taken into account.

In an embodiment according to the invention the adjustment of the orientation progression takes place by selecting an orientation progression from a table on the basis of calculations. When the device is for instance used for runners, the different velocities and the associated orientation progressions of the foot during running can be placed in a table. The running style can herein also be of importance in making a better choice.

In another embodiment of the invention the adjustment of the orientation progression takes place by altering parts of the orientation progression on the basis of the calculations. By applying for instance an expert system, fuzzy logic, a neural network or a numeric optimization, such as for instance Nelder-Mead Simplex routines, it becomes possible to modify the orientation progression chosen as standard in a relatively intelligent manner. Using such an intelligent system a smart choice can also be made from a table. It thus becomes possible to wholly adjust the orientation progression to the runner and thereby minimize the measuring error.

In yet another embodiment according to the invention the standard orientation progression can be selected subject to the accelerations measured during the previous stepping movement. During the previous stepping movement a rough estimate can be made of for instance the velocity or the running style, on the basis of determined peaks and valleys in the measured accelerations, wherein a certain orientation progression is then chosen. The iteration procedure for arriving at the smallest possible measuring error is hereby shortened, so that during a route, measurement with the minimal error is achieved sooner.

According to the invention the criteria to be selected for adjustment of the orientation progression can comprise the differences between preconditions given in advance and calculated values. The velocity is calculated on the basis of the accelerations and the orientation progression. At the end of the step, the resulting velocity vector and the average velocity perpendicular of the running direction must be zero again. If this is not the case, then the orientation progression must be modified.

In a preferred embodiment according to the invention the processing means are adapted such that in a rest position the orientation of two of the three main directions is determined relative to gravity. Using accelerometers which can also measure gravity, it is possible to determine in rest position how the device is positioned relative to gravity. This allows the device to place in any desired position on the shoe.

When three main directions are measured the processing means are herein more preferably adapted such that after a stepping movement the orientation of the three main directions is determined relative to the resulting velocity vector, which is by definition the running direction. After a stepping movement the part of the measured acceleration vector which describes the swing/flight phase is used to determine the angle which the sensors form to the running direction. This part of the data is transformed using the two angles which were determined during standstill. The acceleration vector can then be projected onto the ground plane. This projection describes a line in the ground plane, which line forms an angle with the two already determined main directions. This latter angle is the angle which the sensors form to the running direction. The direction of the line can be found using for instance a least squares method. Together with the orientation relative to gravity it is thus possible to determine how the three main directions are orientated relative to the running direction. The iteration process for arriving at a good orientation progression and a minimum error is hereby shortened, and an automatic calibration of the device takes place. It is hereby also possible to place the device in any desired position on the shoe.

The processing of the measured accelerations takes place by integration on the basis of an orientation progression. This orientation progression preferably describes the orientation of the foot during one step. It is therefore important to be able to distinguish the different successive steps from each other.

In order to be able to determine the beginning and end of the stepping movement, it is of course possible to arrange a pressure switch in the contact surface between the object and the earth, but according to a preferred embodiment of the invention the processing means are adapted such that the end of a stepping movement, and thus the beginning of the subsequent stepping movement, is determined on the basis of the measured accelerations. When the object touches the ground, the measured accelerations will as a result of the shock differ considerably from the accelerations during the step, and it hereby becomes possible to determine when the stepping movement is completed. The end of the stepping movement and the beginning of the following step is particularly defined as the moment after the differing accelerations. The object then stands still for a short time on the ground. The only measured acceleration is then gravity, on the basis of which the direction of gravity relative to the sensors can be determined. Together with the running direction which can be determined from the measured accelerations of the previous step, the device can be calibrated automatically.

Using the found step duration it is possible to predict the following step and this following step then only has to be verified.

In a preferred embodiment according to the invention display means are accommodated in a wristwatch, such that a runner can readily see what his velocity is and for instance the distance traveled. Other functions can of course also be included in this watch, such as a stopwatch and time indication. The display means are preferably in wireless connection with the processing means and/or the measuring means are in wireless connection with the processing means.

### BRIEF DESCRIPTION OF THE DRAWINGS

These and other features according to the invention will be further elucidated with reference to the accompanying drawings.

FIG. 1 shows a runner who is wearing the device according to the invention.

FIG. 2 shows the foot of the runner according to FIG. 1.

FIG. 3 shows a schematic representation of an embodiment according to the invention.

FIG. 4 shows schematically a component of FIG. 3 in more detail.

FIG. 5 shows a flow diagram of an embodiment according to the invention.

### DETAILED DESCRIPTION OF THE PREFERRED EMBODIMENTS

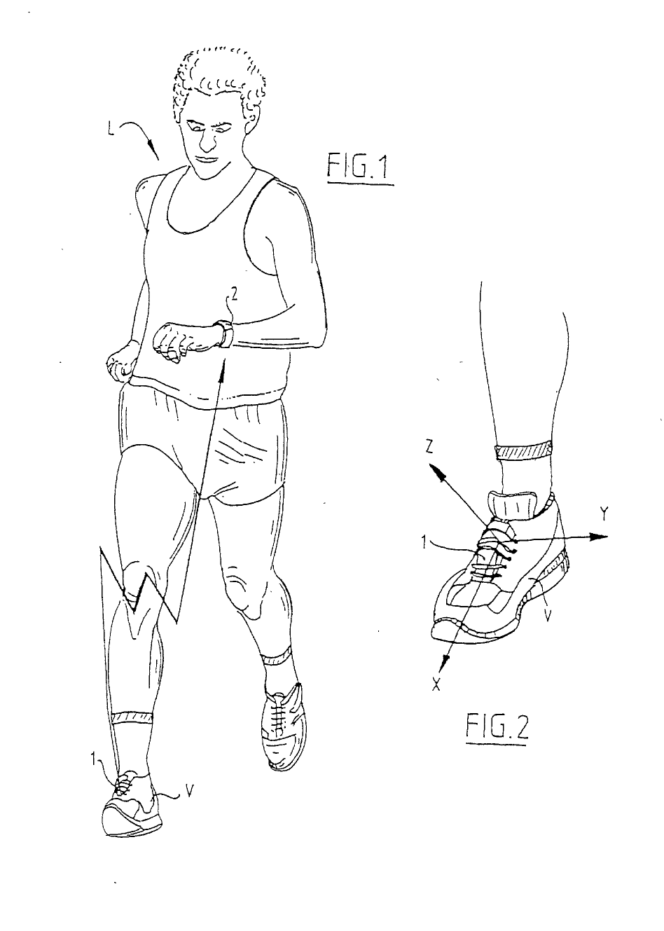

FIG. 1 shows a runner L who is wearing a device 1 on a foot V. Runner L further has a watch 2 on his wrist, on which he can read the calculated values of device 1. The data of device 1 is transmitted in wireless manner to wristwatch 2.

In FIG. 2 the foot V is further shown. Device 1 is placed on the instep. Device 1 can of course also be placed elsewhere on the foot. Further shown are the three main directions in which device 1 measures. These main directions X, Y, Z are rotated relative to foot V.

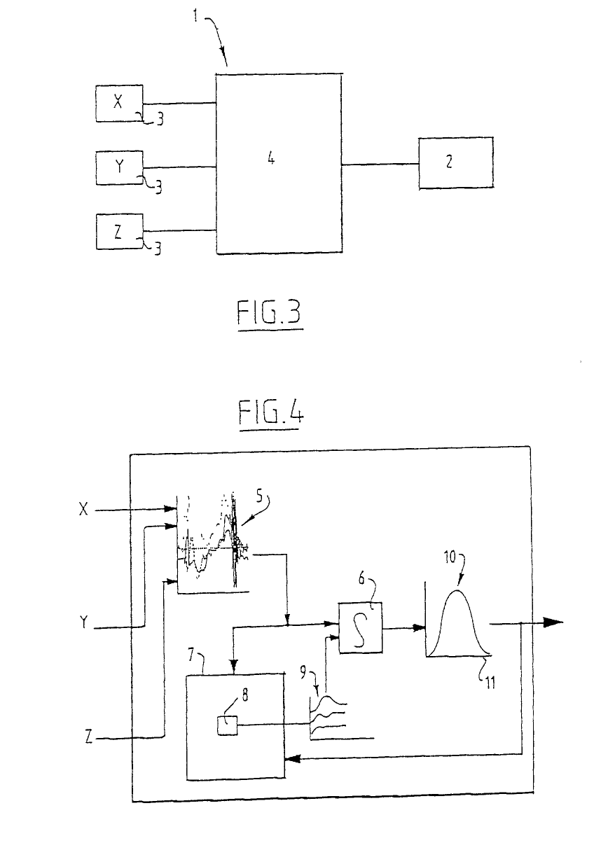

The device 1 is shown schematically in FIG. 3. Device 1 comprises three acceleration sensors 3 which each measure the accelerations in a main direction X, Y, Z. The measured accelerations are then fed to a processing unit 4, which performs calculations on the basis of these accelerations and subsequently passes calculated values to wristwatch 2. The processing unit can be arranged on the shoe, in the watch or at another position.

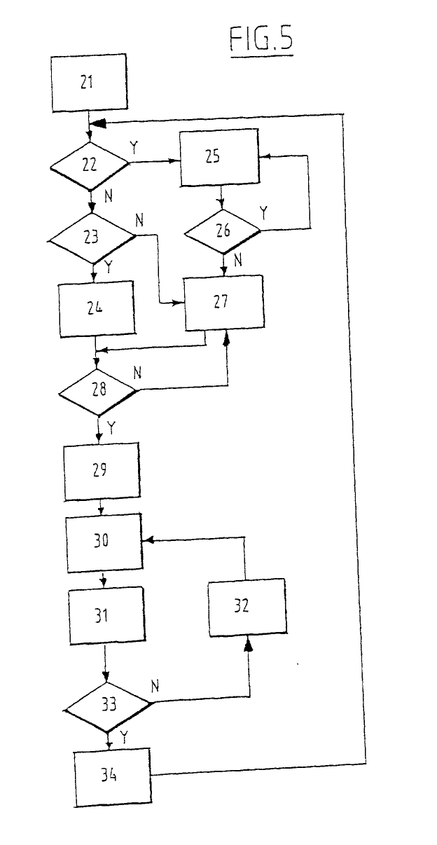

FIG. 4 shows in more detail how a part of processing unit 4 can operate in a preferred embodiment. The three measured accelerations X, Y, Z are collected and for the sake of clarity are represented as a graph 5 in which the accelerations of one step are shown as a function of time. The accelerations are transmitted to a calculating unit 6 where these accelerations are integrated. The accelerations are likewise transmitted to a search table 7 where a standard orientation progression 8 is chosen. This orientation progression is represented as a graph 9 and is likewise passed to calculating unit 6. This angular progression is necessary to enable transforming of the three main directions X, Y, Z into a coordinate system, wherein gravity is one of the main directions and the running direction (or sagittal direction) is another. Integration then takes place wherein the gravity is subtracted from the measured accelerations if absolute acceleration sensors are used. After the integration by calculating unit 6, a velocity progression of one step is obtained. This velocity progression or a processing thereof, such as average velocity or distance, can be transmitted to the wristwatch. If the resulting velocity at the end of the step at the position of reference numeral 11 in graph 10 is not equal to zero, the standard orientation progression has to be modified by feedback to search table 7 until the error is minimal, i.e. below a threshold value. The orientation progression must also be modified when the average velocity transversely of the running direction is not zero.

The calculated velocity progression 10 can be averaged in order to calculate an average velocity of the step, or can be integrated once again in order to enable calculation of the step length.

The successive step lengths can then be added together to calculate the distance traveled. Velocity and distance traveled can be transmitted to the display means, as well as parameters such as the number of steps per minute (the frequency), distance countdown and the minimum and maximum velocity achieved.

Since all physical parameters are measured and/or calculated, these parameters can be stored. These parameters can then be analyzed in order to for instance improve the running technique of an athlete. This can also be used in rehabilitation.

Another advantage of the invention is that the velocity is determined real-time. This means that the current velocity at any moment is known.

FIG. 5 shows a flow diagram of an embodiment according to the invention. The measuring cycle is started in block 21. It is determined first of all at 22 whether the user is standing still. If this is not the case, it is determined at 23 whether a periodic signal was found earlier. If this is the case, the periodicity found will be checked against the expectation in 24 and small modifications will optionally be made in the duration of the step.

If it is established at 22 that the user is standing still, the inclination of the sensor relative to gravity will be determined at 25 and two main directions are determined. It is then determined at 26 whether the user is standing still. If this is the case, the inclination of the sensor will then be determined once again at 25. If the user is not standing still, the periodicity in the acceleration signal will then be determined at 27. The beginning and the duration of the first step is thus retrieved.

Hereafter, or after the operations of 24 have been performed, it is determined whether the values found for beginning and duration of the step are within the expected range. If this is not the case, the periodicity in the acceleration signal will be determined once again at 27.

If however the values for beginning and duration of the step are correct, the angle which the sensor forms with the running direction is then determined at 29. Using the orientation progression the measured accelerations of one step are then transformed in 30 to the coordinate system of the earth. The accelerations are then numerically integrated into the coordinate system in 31.

After integration it is determined at 33 whether the calculated velocity progression corresponds with the given preconditions, such as the condition that at the end of the step the resulting velocity is zero and the average velocities transversely of the running direction are zero. If this is not the case, the orientation progression will be adjusted at 32 by means of a table, an expert system, fuzzy logic, a numeric optimization or neural network.

If the given preconditions are satisfied in 33, the average velocity of the step is then calculated and the following step can be measured and calculated.

What is claimed is:

1. A device for determining the velocity and, optionally, the distance traveled by an object through measuring successive stepping movements of the object, which device comprises:
(a) measuring means for measuring the acceleration of the object in two main directions during a stepping movement;
(b) processing means for determining the velocity from the measured accelerations, wherein the processing means are configured such that, on the basis of an orientation progression, the measured accelerations are integrated to a velocity and optional determination of the distance traveled; and
(c) means for displaying the velocity and, optionally, the distance traveled as calculated by the processing means.

2. The device as claimed in claim 1, wherein the measuring means measure the acceleration of the object in a third main direction.

3. The device as claimed in claim 2, wherein the processing means are configured such that after a stepping movement the orientation of the three main directions is determined relative to the resulting velocity vector.

4. The device as claimed in claim 1, wherein the orientation progression of the object during a first stepping movement is selected from a series of orientation progressions.

5. The device as claimed in claim 1, wherein the orientation progression is modified on the basis of criteria to be chosen in order to calculate a following stepping movement.

6. The device as claimed in claim 5, wherein the modification of the orientation progression takes place by selecting an orientation progression from a table on the basis of the calculations.

7. The device as claimed in claims 4 or 6, wherein the selection of the orientation progression depends on the accelerations measured during the previous stepping movement.

8. The device as claimed in claim 5, wherein the modification of the orientation progression takes place by altering parts of the orientation progression on the basis of the calculations.

9. The device as claimed in claim 5, wherein the criteria to be chosen comprise differences between preconditions given in advance and calculated values.

10. The device as claimed in claim 1, wherein the processing means are configured such that in a rest position the orientation of the three main directions is determined relative to gravity.

11. The device as claimed in claim 1, wherein the processing means are configured such that the end of a stepping movement is determined on the basis of the measured accelerations.

12. The device as claimed in claim 1, wherein the connection of the display means, the measuring means and/or the processing means is wireless.

13. The device as claimed in claim 1, wherein the display means are accommodated in a wristwatch.

14. A method for calibrating a device as claimed in claim 2, comprising the steps of:
determining a rest moment on the basis of the measured accelerations after the object has ended the stepping movement;
determining the orientation of the gravitational acceleration at the rest moment;
inputting the determined orientation of the gravitational accelerations into the processing means such that, on the basis of the determined orientation of the gravitational acceleration and the running direction to be calculated from the measured accelerations of the previous step, the processing means can calibrate the integration of the measured accelerations.
